(19) United States
(12) Patent Application Publication
(10) Pub. No.: US 2024/0020477 A1
(43) Pub. Date: Jan. 18, 2024

(54) SYSTEM AND METHOD FOR USING RESIDUAL TRANSFORMERS IN NATURAL LANGUAGE PROCESSING

(71) Applicant: Samsung Electronics Co., Ltd., Suwon-si (KR)

(72) Inventors: Sai Ajay Modukuri, San Francisco, CA (US); Brendon Christopher Beachy Eby, Chicago, IL (US); Suhel Jaber, San Jose, CA (US)

(21) Appl. No.: 18/306,881

(22) Filed: Apr. 25, 2023

Related U.S. Application Data
(60) Provisional application No. 63/388,957, filed on Jul. 13, 2022.

(51) Int. Cl. G06F 40/284; G06F 40/40

(52) U.S. Cl. CPC G06F 40/284; G06F 40/40

(57) ABSTRACT

A method includes providing embedding vectors representing tokens in an input to a transformer comprising multiple transformer layers arranged in a sequence, each transformer layer having a residual connection to each previous transformer layer. The method also includes, for each transformer layer, determining, for a first token, an input embedding vector based on a combination of output embedding vectors from previous transformer layers. The method further includes, for each transformer layer, processing, for the first token, the input embedding vector to generate an output embedding vector to be provided to each subsequent transformer layer.

### CROSS-REFERENCE TO RELATED APPLICATION AND PRIORITY CLAIM

This application claims priority under 35 U.S.C. § 119(e) to U.S. Provisional Patent Application No. 63/388,957 filed on Jul. 13, 2022, which is hereby incorporated by reference in its entirety.

### TECHNICAL FIELD

This disclosure relates generally to natural language processing systems. More specifically, this disclosure relates to a system and method for using residual transformers in natural language processing.

### BACKGROUND

Transformer architecture-based language models like BERT provide good performance in many natural language processing (NLP) tasks. At their core, these models are built by stacking multiple transformer layers on top of each other in a sequential manner. The input passes through each of the transformer layers, where the output of one transformer layer is used as the input for the layer above it. It has been found that the ability of these transformer-based language models to solve a task and adapt to new NLP tasks is directly proportional to the number of transformer layers stacked on top of each other. However, deeper language models with large numbers of transformer layers have some drawbacks, such as slower training times and weaker loss signal propagation to initial layers.

### SUMMARY

This disclosure provides a system and method for using residual transformers in natural language processing.

In a first embodiment, a method includes providing embedding vectors representing tokens in an input to a transformer comprising multiple transformer layers arranged in a sequence, each transformer layer having a residual connection to each previous transformer layer. The method also includes, for each transformer layer, determining, for a first token, an input embedding vector based on a combination of output embedding vectors from previous transformer layers. The method further includes, for each transformer layer, processing, for the first token, the input embedding vector to generate an output embedding vector to be provided to each subsequent transformer layer.

In a second embodiment, an electronic device includes at least one processing device configured to provide embedding vectors representing tokens in an input to a transformer comprising multiple transformer layers arranged in a sequence, each transformer layer having a residual connection to each previous transformer layer. The at least one processing device is also configured to, for each transformer layer, determine, for a first token, an input embedding vector based on a combination of output embedding vectors from previous transformer layers. The at least one processing device is further configured to, for each transformer layer, process, for the first token, the input embedding vector to generate an output embedding vector to be provided to each subsequent transformer layer.

In a third embodiment, a non-transitory machine-readable medium contains instructions that when executed cause at least one processor of an electronic device to provide embedding vectors representing tokens in an input to a transformer comprising multiple transformer layers arranged in a sequence, each transformer layer having a residual connection to each previous transformer layer. The medium also contains instructions that when executed cause the at least one processor to, for each transformer layer, determine, for a first token, an input embedding vector based on a combination of output embedding vectors from previous transformer layers. The medium further contains instructions that when executed cause the at least one processor to, for each transformer layer, process, for the first token, the input embedding vector to generate an output embedding vector to be provided to each subsequent transformer layer.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example residual transformer according to this disclosure;

FIG. 3 illustrates details of an example transformer layer according to this disclosure;

FIG. 4 illustrates an example residual-attention transformer according to this disclosure;

FIG. 5 illustrates an example of vertical residual-attention, which can be performed in the residual-attention transformer of FIG. 4 according to this disclosure;

FIG. 6 illustrates an illustrates an example of hyper-attention, which can be performed in the residual transformer of FIG. 2 according to this disclosure;

FIG. 7 illustrates an example of dense-attention according to this disclosure;

FIG. 8 illustrates an example transformer layer for performing dense-attention according to this disclosure; and

FIG. 9 illustrates an example method for using residual transformers in natural language processing according to this disclosure.

### DETAILED DESCRIPTION

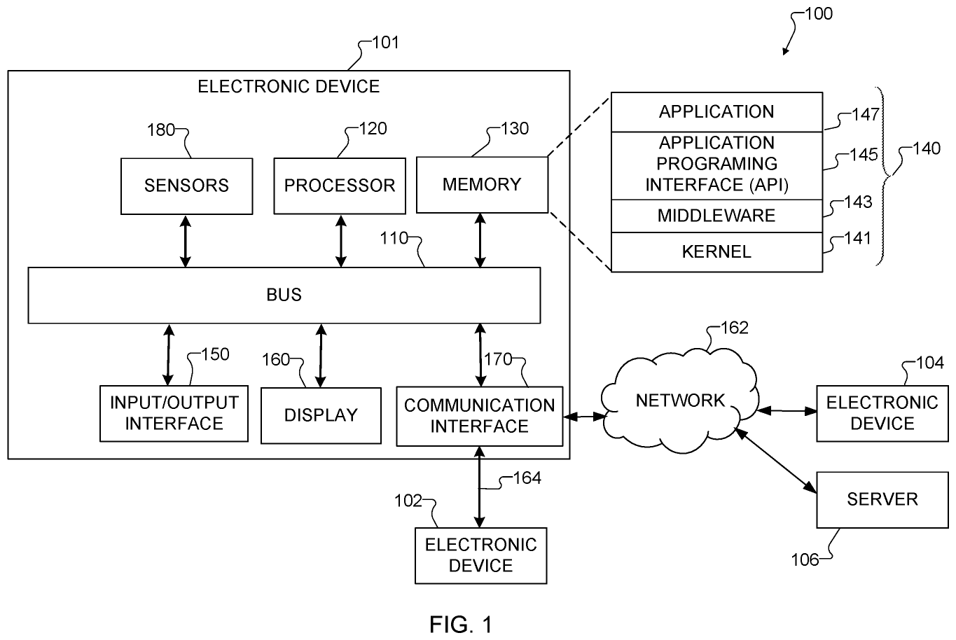

FIGS. 1 through 9, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As discussed above, transformer architecture-based language models like BERT provide good performance in many NLP tasks. At their core, these models are built by stacking multiple transformer layers on top of each other in a sequential manner. The input passes through each of the transformer layers, where the output of one transformer layer is used as the input for the layer above it.

It has been found that the ability of these transformer-based language models to solve a task and adapt to new NLP tasks is directly proportional to the number of transformer layers stacked on top of each other. This resulted in development and adoption of deeper language models with larger numbers of transformer layers stacked together (such as the GPT-3 model includes 96 transformer layers). However, the deeper language models have some drawbacks, such as slower training times and weaker loss signal propagation to initial layers. Moreover, the lower layers of language models capture phrase-level information, while the middle layers capture syntactic information. However, this information gets lost or diluted in the upper layers of language models. Thus, it would be advantageous to make this rich phrase-level, syntactic information available to upper layers of language models.

There have been some attempts to introduce residual connections within transformer architecture, but they are limited in scope and results. For example, one such technique adds pre-SoftMax attention scores from the layer L−2 to the current layer L. Although this technique provides a path for direct loss propagation, it does not add any of the rich syntactic, phrase-level information from the lower layers. Moreover, this technique is simply a naïve addition of attention scores from previous layers to provide a direct path for loss propagation.

This disclosure provides various techniques for using residual transformers in natural language processing. As described in more detail below, the disclosed systems and methods provide various advanced architectures that can help bring this information extracted at lower layers of language models available to upper layers, while also addressing the above stated issues using residual connections. The disclosed embodiments provide the upper layers of language models with rich syntactic text features, which can be leveraged for better task solving abilities and better task specific optimization. This can lead to improvements in language understanding and reductions in perplexity. This can also result in faster convergence, less computation, and reduced costs for training.

Note that while some of the embodiments discussed below are described in the context of use in consumer electronic devices (such as smart phones), this is merely one example, and it will be understood that the principles of this disclosure may be implemented in any number of other suitable contexts and may use any suitable devices.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform one or more operations for using residual transformers in natural language processing.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for using residual transformers in natural language processing. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a cellular communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 include one or more cameras or other imaging sensors for capturing images of scenes. The sensor(s) 180 can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

The first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform one or more operations to support techniques for using residual transformers in natural language processing.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

As noted above, residual connections can be used in transformer architectures to smooth the loss landscape, thereby reducing training times and computational costs. Residual connections can achieve these benefits by allowing features extracted at lower level layers to be accessible to layers at higher levels. The embodiments described below include advanced transformer language model architectures that use residual connections to extract phrase-level, linguistic, and syntactic features at lower layers. These rich features extracted at lower layers are thereby made accessible to upper layers, while also providing for faster training of the models. The advanced transformer language model architectures described herein include the following:

1. Residual transformer architecture. This architecture includes simple residual connections across transformer layers. In this architecture, each n^{th} transformer layer receives residual outputs from the first to the (n−1)th transformer layers.

2. Vertical Residual-Attention architecture. Instead of adding residuals at each layer, this architecture uses an attention layer to decide which of the features from lower layers are meaningful for the current layer. For each token, vertical-residual attention attends to the same token from the layers below it.

3. Vertical-Horizontal Residual-Attention architecture. In this architecture, residual attention attends to all the tokens from all the layers below it.

4. Hyper-Attention architecture. In this architecture, a self attention mechanism in a transformer layer is modified to attend to all tokens at the current transformer layer and also to all tokens extracted from the layers below it.

5. Dense-Attention architecture. This architecture modifies the current transformer layer, which allows for information flow from multiple heads to the next layer. At each layer, each attention head attends to all token outputs from multiple heads of previous layers.

The advanced transformer language model architectures described herein also can include one or more layer embeddings or head embeddings. These embeddings augment the output from each transformer layer with information indicating which layer or head the embedding belong to. For example, a layer embedding from transformer layer 3 includes information that indicates that the output is from transformer layer 3. The layer embeddings can be used in any of the architectures described herein. In some embodiments, the layer embeddings can be encoded using an addition operation. For example, at layer n, the addition operation between the layer output and the layer embeddings for that particular layer can be given by the following equation:

FinalOutputOfLayerₙ=OutputOfLayerₙ+LayerEmbeddingsₙ

Throughout this patent document, when the output from a layer is referenced, it is assumed that the layer output may be encoded with layer embeddings, such as described by the above equation.

Residual Transformer Architecture

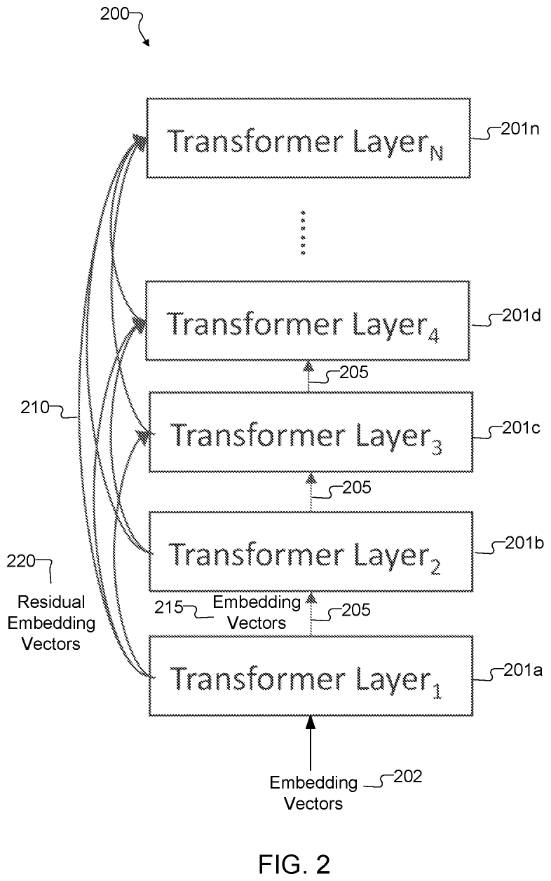

FIG. 2 illustrates an example residual transformer 200 according to this disclosure. For ease of explanation, the residual transformer 200 is described as being implemented using one or more components of the network configuration 100 of FIG. 1 described above, such as the electronic device 101. However, this is merely one example, and the residual transformer 200 could be implemented using any other suitable device(s) and in any other suitable system(s).

As shown in FIG. 2, the residual transformer 200 includes multiple (N) transformer layers 201a-201n arranged in a sequence. Here, N is any suitable integer number greater than one. The residual transformer 200 includes connections 205 between adjacent transformer layers 201a-201n for providing information, such as embedding vectors (as described in greater detail below). In addition, the residual transformer 200 includes residual connections 210 between non-adjacent transformer layers 201a-201n. Specifically, each of the transformer layers 201a-201n has a residual connection 210 to each non-adjacent transformer layer 201a-201n. For example, the transformer layer 201a, which is the first transformer layer in the sequence, has a residual connection 210 to each the transformer layers 201c-201n. The transformer layer 201b, which is the second transformer layer in the sequence, has a residual connection 210 to each the transformer layers 201d-201n.

The transformer layer 201a receives multiple embedding vectors 202 as an input to the residual transformer 200. The embedding vectors 202 represent tokens corresponding to a transformer input. In some embodiments, the tokens can correspond to a natural language utterance (such as “Where is my cat?”) that is to be processed using the residual transformer 200. Of course, this is merely one example, and the tokens can correspond to other types of information.

The transformer layer 201a processes the embedding vectors 202 for each token to generate multiple output embedding vectors representing the tokens. As shown in FIG. 2, the output embedding vectors include output embedding vectors 215, which are provided as input to the next transformer layer 201b, and residual embedding vectors 220, which are provided as input to each of the higher, non-adjacent, transformer layers 201c-201n.

The subsequent transformer layers 201b-201n receive the output embedding vectors from previous transformer layer(s) 201a-201n, which include the output embedding vectors 215 from the adjacent previous transformer layer 201a-201n and, in the case of the transformer layers 201c-201n, the residual embedding vectors 220 from non-adjacent previous transformer layers 201a-201n.

Each transformer layer 201b-201n determines, for each received token, an input embedding vector based on a combination of the output embedding vectors 215 and the residual embedding vectors 220, which are received from the previous transformer layers 201a-201n. Each transformer layer 201b-201n then processes, for each token, the input embedding vector to generate an output embedding vector to be provided to each subsequent transformer layer.

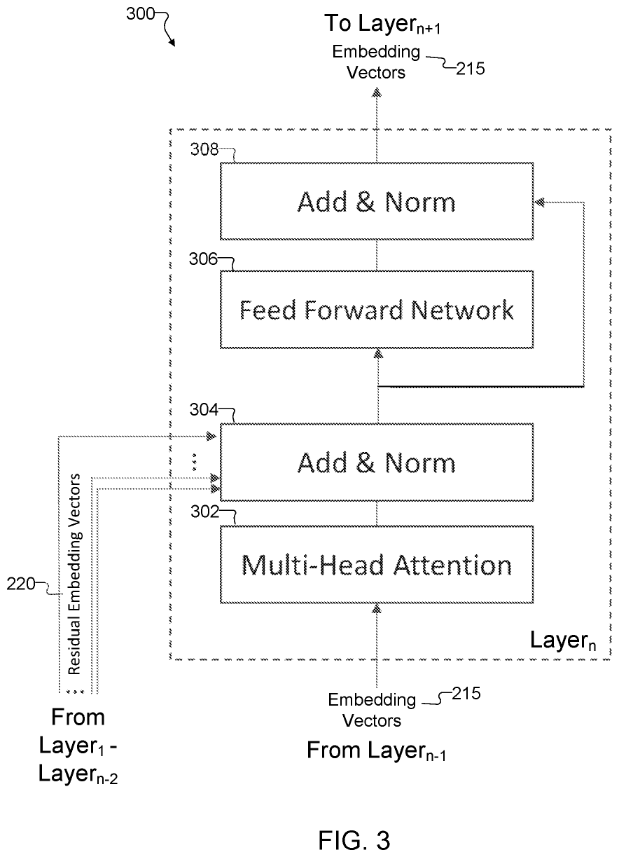

FIG. 3 illustrates further details of an example transformer layer 300 according to this disclosure. The transformer layer 300 can represent one of the transformer layers 201a-201n in the residual transformer 200.

As shown in FIG. 3, the transformer layer 300 includes a multi-head attention block 302, an add & norm block 304, a feed forward network 306, and an add & norm block 308. The multi-head attention block 302 computes queries, keys, and values for each of multiple heads in parallel. The queries, keys, and values are used to compute attention weights for the multiple heads. A weighted average is then performed to get contextual representations for each token, which are then concatenated and projected using a linear layer. The add & norm blocks 304 and 308 perform layer addition and layer normalization. The feed forward network 306 is a fully connected layer that receives the output from the add & norm block 304.

In contrast to conventional transformer architectures, where each transformer layer (n) only receives input from the one adjacent previous layer (n−1), the transformer layer 300 (which can represent layer n) receives input from the adjacent previous layer (n−1) and other, non-adjacent previous layers (layers 1˜n−2). Stated differently, each transformer layer n receives outputs from transformer layer 1 to transformer layer (n−1). In particular, as shown in FIG. 3, the transformer layer 300 receives the output embedding vectors 215 from the adjacent previous layer (n−1), which are provided as an input to the multi-head attention block 302. The transformer layer 300 also receives the residual embedding vectors 220 from the non-adjacent previous layers (layers 1˜n−2). The add & norm block 304 then adds and normalizes (such as using layer normalization) the outputs from the layers 1 to (n−1). This can be expressed by the following:

$$Input to layer n ( {I}_{n} ) = LayerNorm ( {\sum }_{k = 1}^{n - 1} OutputOfTransformerLayer ( k ) ) .$$

The inclusion of the residual embedding vectors 220 from the non-adjacent previous layers provides faster training and convergence times in the transformer layer 300, thus enabling easier training of deeper networks and improvement in performing natural language tasks.

Although FIGS. 2 and 3 illustrate one example of a residual transformer 200 and related details, various changes may be made to FIGS. 2 and 3. For example, while the residual transformer 200 is described with various examples of components and operations, other embodiments could include other components and/or other operations. Also, while shown as a specific sequence of operations, various operations shown in FIGS. 2 and 3 could overlap, occur in parallel, occur in a different order, or occur any number of times (including zero times). As a particular example, while FIG. 3 shows the transformer layer 300 receiving the residual embedding vectors 220 in the add & norm block 304, the transformer layer 300 could alternatively receive the residual embedding vectors 220 at the input to the transformer layer 300, before the multi-head attention block 302.

Residual-Attention Architecture

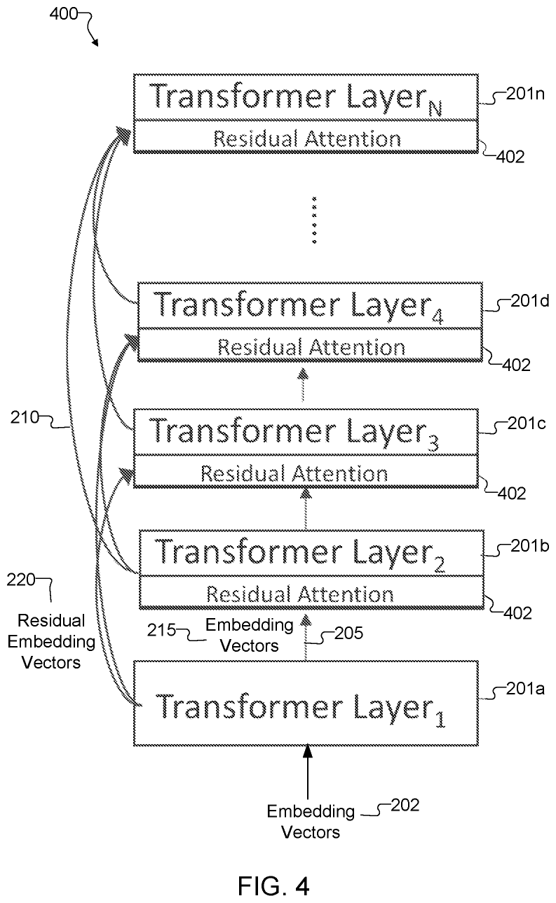

FIG. 4 illustrates an example residual-attention transformer 400 according to this disclosure. For ease of explanation, the residual-attention transformer 400 is described as being implemented using one or more components of the network configuration 100 of FIG. 1 described above, such as the electronic device 101. However, this is merely one example, and the residual-attention transformer 400 could be implemented using any other suitable device(s) and in any other suitable system(s).

As shown in FIG. 4, the residual-attention transformer 400 includes many components that are the same as, or similar to, corresponding components of the residual transformer 200. For example, the residual-attention transformer 400 includes multiple (N) transformer layers 201a-201n arranged in a sequence, connections 205 between adjacent transformer layers 201a-201n for providing embedding vectors, and residual connections 210 between non-adjacent transformer layers 201a-201n.

The residual-attention transformer 400 also includes a residual attention layer 402 for each of the upper transformer layers 201b-201n. In contrast to the residual transformer 200, in which residuals are added at each of the upper transformer layers 201b-201n (without any decision as to which features to include), the residual attention layer 402 for a particular transformer layer 201b-201n decides which of the features from the lower transformer layers 201a-201n are meaningful for the corresponding transformer layer 201b-201n. The residual attention layer 402 for the n-th transformer layer 201b-201n uses the outputs from the lower transformer layers 201a-201n (1˜n−1) to compute a weighted sum, which is then provided as an input to the n-th transformer layer 201b-201n. As described in greater detail below, the weighted sum is based on the embedding vectors 215 from the adjacent previous transformer layer (n−1) and the residual embedding vectors 220 from the non-adjacent previous transformer layers (1˜n−2), modified by a set of attention weights for the embedding vectors 215 and 220. Thus, instead of just adding residual connections across transformer layers, the residual-attention transformer 400 includes dynamic decision making through residual attention, allowing the upper transformer layers 201b-201n to choose how much of the information to pick from the transformer layers 201a-201n below it.

As with the residual transformer 200, the residual embedding vectors 220 can be introduced to each transformer layer 201a-201n of the residual-attention transformer 400 at the multi-head attention block 302 or at the input to the transformer layer 201a-201n (i.e., before the multi-head attention block 302).

The residual-attention transformer 400 can be configured according to either a vertical residual-attention transformer architecture or a vertical-horizontal residual-attention transformer architecture. The two architectures differ in the manner in which the residual attention is performed, which will now be described.

Vertical Residual-Attention

In the vertical residual-attention transformer architecture, for each token at the current transformer layer 201a-201n, the corresponding residual attention layer 402 attends to representations of the same token from all of the previous transformer layers 201a-201n below the current layer. For example, for token t at layer 1, the residual attention layer 402 calculates the vertical residual attention Attention_{l,t} as follows:

Attention_{l,t}(Q,K,V)=SoftMax(QK^{T})V
where Q=e_{l-1,t}w_{l,t}^{Q}
   K=e_{1:l-1,t}wₗₜ^{K}
   V=e_{1:l-1,t}wₗₜ^{V}
      where w represents learned attention weights for each of the K (key), Q (query), and V (value) projections; e_{1:l-1,t} represents embeddings from layers 1 through l−1 for token t; and e_{l-1,t} represents embeddings from layer l−1 for token t.

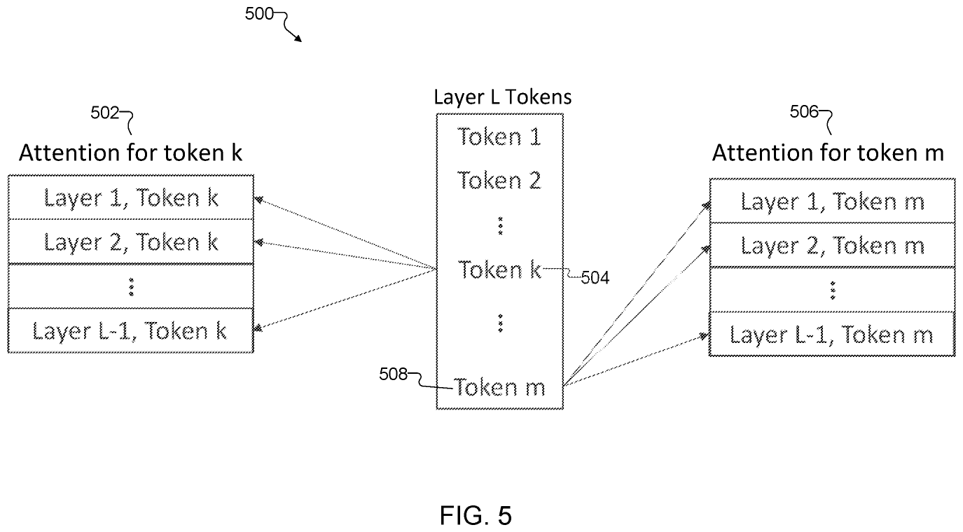

FIG. 5 illustrates an example 500 of vertical residual-attention in the residual-attention transformer 400 according to this disclosure. As shown in FIG. 5, the vertical residual attention 502 for token k 504 at layer L is calculated using the tokens k at each of the previous layers 1 through L−1. Similarly, the vertical residual attention 506 for token m 508 at layer L is calculated using the tokens m at each of the previous layers 1 through L−1. Thus, in the residual-attention transformer 400, the resulting embedding vectors 215 are determined by calculating a weighted sum of the set of output embedding vectors 215 from the previous layers based on the set of attention weights in the vertical residual-attention Attention_{l,t}.

Vertical-Horizontal Residual-Attention

The vertical-horizontal residual-attention transformer architecture is similar to the vertical residual-attention transformer architecture, but differs from the vertical residual-attention transformer architecture by the following: Instead of just attending to the same tokens from all of the layers below, the vertical-horizontal residual-attention transformer architecture attends to all tokens from all of the layers below. That is, in the vertical-horizontal residual-attention transformer architecture, for a current transformer layer 201a-201n, the corresponding residual attention layer 402 attends to all of the tokens from all of the previous transformer layers 201a-201n below the current layer.

For example, for layer 1 and token t, the residual attention layer 402 calculates the vertical-horizontal residual-attention Attention_{l,t} as follows:

Attention_{l,t}(Q,K,V)=SoftMax(QK^{T})V
where Q=e_{l-1,t}w_{l,t}^{Q}
   K=e_{1:l-1,[T]}w_{l,t}^{K}
   V=e_{1:l-1,[T]}w_{l,t}^{V}
      where w represents learned attention weights for each of the K, Q, and V projections; e_{1:l-1,[T]} represents embeddings from layers 1 through l−1 for all tokens [0, 1, . . . T]; and e_{l-1,t} represents embeddings for layer l−1 and token t. Thus, in the residual-attention transformer 400, the resulting embedding vectors 215 are determined by calculating a weighted sum of all of the sets of output embedding vectors 215 from the previous layers based on all sets of attention weights in the vertical-horizontal residual-attention Attention_{l,t}.

Although FIGS. 4 and 5 illustrate examples of a residual-attention transformer 400 and related details, various changes may be made to FIGS. 4 and 5. For example, while the residual-attention transformer is described with various examples of components and operations, other embodiments could include other components and/or other operations. Also, while shown as a specific sequence of operations, various operations shown in FIGS. 4 and 5 could overlap, occur in parallel, occur in a different order, or occur any number of times (including zero times).

Hyper-Attention Architecture

Modifications to the transformer 200 can be introduced to facilitate a hyper-attention architecture. In particular, self-attention operations performed by the multi-head attention block 302 of each transformer layer 201a-201n can be modified as described below.

In a conventional transformer, multi-head self-attention is performed at a given transformer layer n using only the output of the previous adjacent transformer layer (n−1), as expressed by the following:

MultiHead(Q,K,V)=Concat(head₁,head₂, . . . ,headₕ)
where headᵢ=Attention(Qᵢ, Kᵢ, Vᵢ)
   Qᵢ=XWᵢ^{Q}, Wᵢ^{Q}∈ [symbol] ^{d}^{_{model}}^{*d}^{ₖ}
   Kᵢ=XWᵢ^{K}, Wᵢ^{K}∈ [symbol] ^{d}^{_{model}}^{*d}^{ₖ}
   Vᵢ=XWᵢ^{V}, Wᵢ^{V}∈ [symbol] ^{d}^{_{model}}^{*d}^{ₖ}

In the above equations, X represents the output from the previous adjacent transformer layer, i.e., layer n−1.

In the hyper-attention architecture disclosed herein, for each token in a given transformer layer n, the multi-head attention block 302 attends to all of the tokens not only in X (i.e., the output from the previous adjacent transformer layer, n−1), but also to the output tokens of all the layers below n−1 (i.e., n−2, n−3, etc.). Thus, for the transformer layer n, self-attention is performed for each of the multiple heads to determine a weighted sum of output embedding vectors for all tokens from all the previous transformer layers for a same head. The weighted sums for the multiple heads are then combined. This can be expressed by the following:

HyperMultiHead(Q,K,V)=Concat(head₁,head₂, . . . ,headₕ)W^{O}
where headᵢ=Attention(Qᵢ, Kᵢ, Vᵢ)
Qᵢ=Xₙ₋₁Wᵢ^{Q}, Wᵢ^{Q}∈ [symbol] ^{d}^{_{model}}^{*d}^{ₖ}
   Kᵢ=YWᵢ^{K}, Wᵢ^{K}∈ [symbol] ^{d}^{_{model}}^{*d}^{ₖ}
   Vᵢ=YWᵢ^{V}, Wᵢ^{V}∈ [symbol] ^{d}^{_{model}}^{*d}^{ₖ}
   Y=Concat(Xₙ₋₁, Xₙ₋₂, . . . , X₀)

In the above equations, W^{O} represents the projection/feedforward layer, and Xₖ represents the token outputs from the transformer layer K.

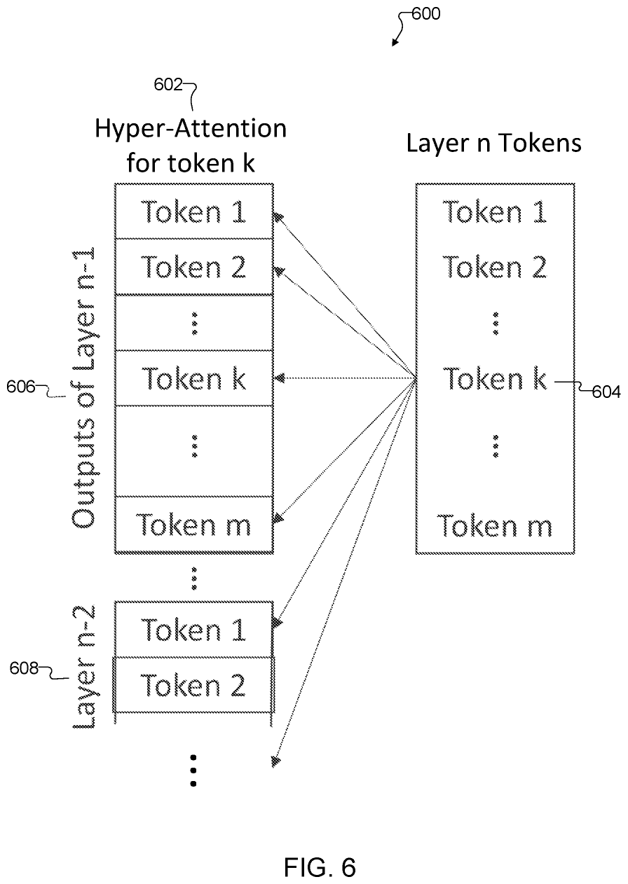

FIG. 6 illustrates an illustrates an example 600 of hyper-attention, which can be performed in the transformer 200 according to this disclosure. As shown in FIG. 6, the hyper-attention 602 for token k 604 at layer n is calculated using the all of the tokens 606 of the transformer layer n−1 and all of the tokens 608 at each of the previous layers 1 through n−2.

Hyper-Attention Architecture with Learnable Down-Weighting

In some embodiments, the hyper-attention architecture can be modified to allows the multi-head attention block 302 of each transformer layer 201a-201n to collectively down-weight the attention attributed to the non-adjacent previous transformer layers. The down-weighting reduces the impact of the non-adjacent previous transformer layers, so that the attention mechanism is not overtaken by the residual connections from those layers. For example, for transformer layer l, the attention attributed to the non-adjacent previous transformer layers 1˜l−2 can be reduced by down-weighting. The attention attributed to the adjacent previous transformer layer l−1 is not down-weighted.

To achieve the down-weighting, a predetermined, learnable bias parameter b can be subtracted from the attention scores QK^{T} corresponding to the residual connections, as follows:

Attention_{l,t}(Q,K,V)=SoftMax([QK_{1:l-1}^{T}−b;QKₗ^{T}])V
where Q=e_{l,t}w_{l,t}^{Q}
K_{1:l-1}=e_{1:l-1,t}w_{l,t}^{K}
   Kₗ=e_{l,t}w_{l,t}^{K}
   V=e_{1:l,t}w_{l,t}^{V}
      where w represents attention weights for each of the K, Q, and V projections, e_{l,t} represents the embedding for token t at layer l, and b represents the bias parameter.

Dense-Attention Architecture

The dense-attention architecture is an extension of the hyper-attention architecture described above. The dense-attention architecture allows for an easy flow of information across multiple heads. For this, the dense-attention architecture modifies the HyperMultiHead technique defined in the hyper-attention architecture to accommodate querying on all token embeddings from all the heads from previous layers. Thus, for a given transformer layer, self-attention is performed for each of the multiple heads to determine a weighted sum of output embedding vectors for all tokens from all the previous transformer layers for each of the multiple heads. The weighted sums for the multiple heads are then combined. For example, the HyperMultiHead equation shown above can be modified for dense-attention as follows:

DenseMultiHead(Q,K,V)=Concat(head₁W¹,head₂W², . . . ,headₕW^{h})
where head i=Attention(Qᵢ, Kᵢ, Vᵢ)
Qᵢ=Xᵢⁿ⁻¹Wᵢ^{Q}, Wᵢ^{Q}∈ [symbol] ^{d}^{_{model}}^{*d}^{ₖ}
   Kᵢ=YWᵢ^{K}, Wᵢ^{K}∈ [symbol] ^{d}^{_{model}}^{*d}^{ₖ}
   Vᵢ=YWᵢ^{V}, Wᵢ^{V}∈ [symbol] ^{d}^{_{model}}^{*d}^{ₖ}
   Y=Concat(X_{[h]}ⁿ⁻¹, X_{[h]}ⁿ⁻², . . . , X_{[h]}⁰)

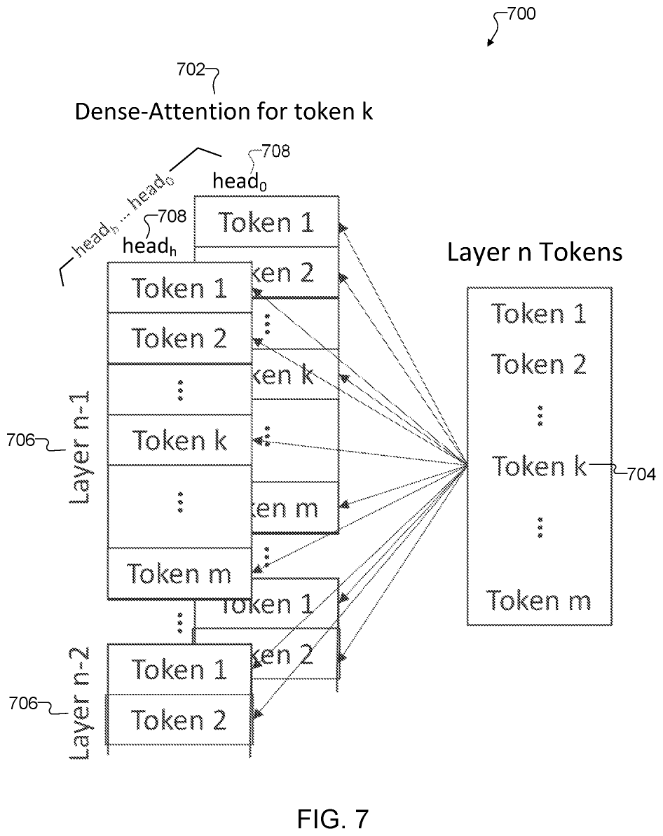

Here X_{[h]}ⁿ represents the token outputs from multiple heads from the transformer layer n. Note that the W^{O} projection/feedforward layer defined in the HyperMultiHead equation has been removed from the DenseMultiHead equation. FIG. 7 illustrates an example 700 of dense-attention according to this disclosure. As shown in FIG. 7, the dense-attention 702 for token k 704 at layer n attends to all previous tokens from previous layers 706 and multiple heads 708.

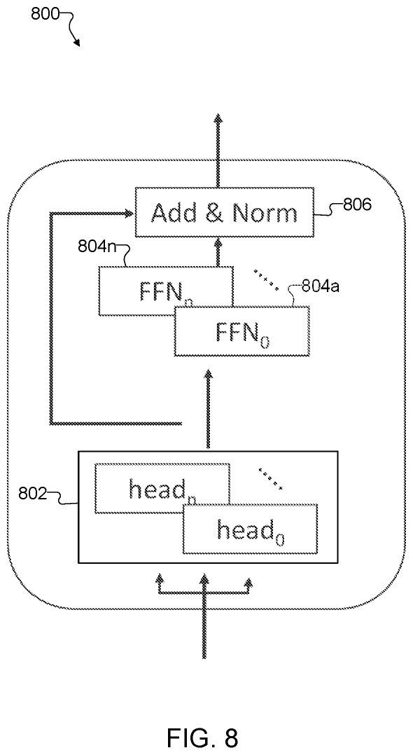

To achieve the dense-attention, the transformer layer 300 of FIG. 3 is modified to have multiple feed forward networks. For example, FIG. 8 illustrates an example transformer layer 800 for performing dense-attention according to this disclosure. The transformer layer 800 can represent one of the transformer layers 201a-201n in the residual transformer 200.

As shown in FIG. 8, the transformer layer 800 includes a multi-head attention block 802, multiple feed forward networks 804a-804n, and an add & norm block 806. The multi-head attention block 802 is similar to the multi-head attention block 302 of FIG. 3. Here, the multiple heads 0˜n of the multi-head attention block 802 are shown. Unlike the transformer layer 300, the transformer layer 800 does not include an add & norm block immediately after the multi-head attention block 802. Also, instead of a single feed forward network, the transformer layer 800 includes multiple feed forward networks 804a-804n—one for each head. These differences between the transformer layer 800 and the transformer layer 300 facilitate information flow from the multiple heads to the next transformer layer in the dense-attention architecture.

The dense-attention architecture can also use multi-head embeddings, which represent from which head a token embedding is received. Similar to layer embeddings, the multi-head embeddings are learned and can be added to the keys at the transformer layer as follows:

Keysᵢ=Keysᵢ+HeadEmbeddingsᵢ

Here, Keysᵢ represents keys for all tokens in the self-attention mechanism for Headᵢ and HeadEmbeddingsᵢ represents the learned head embeddings for Headᵢ.

Although FIG. 6 through 8 illustrate examples for using residual transformers in natural language processing and related details, various changes may be made to FIGS. 6 through 8. For example, while described as involving specific sequences of operations, various operations of the techniques described with respect to FIGS. 6 through 8 could overlap, occur in parallel, occur in a different order, or occur any number of times (including zero times). Also, the specific operations shown in FIGS. 6 through 8 are examples only, and other techniques could be used to perform each of the operations shown in FIGS. 6 through 8.

Note that the operations and functions shown in or described with respect to FIGS. 2 through 8 can be implemented in an electronic device 101, server 106, or other device(s) in any suitable manner. For example, in some embodiments, the operations and functions shown in or described with respect to FIGS. 2 through 8 can be implemented or supported using one or more software applications or other software instructions that are executed by the processor 120 of the electronic device 101, server 106, or other device(s). In other embodiments, at least some of the operations and functions shown in or described with respect to FIGS. 2 through 8 can be implemented or supported using dedicated hardware components. In general, the operations and functions shown in or described with respect to FIGS. 2 through 8 can be performed using any suitable hardware or any suitable combination of hardware and software/firmware instructions.

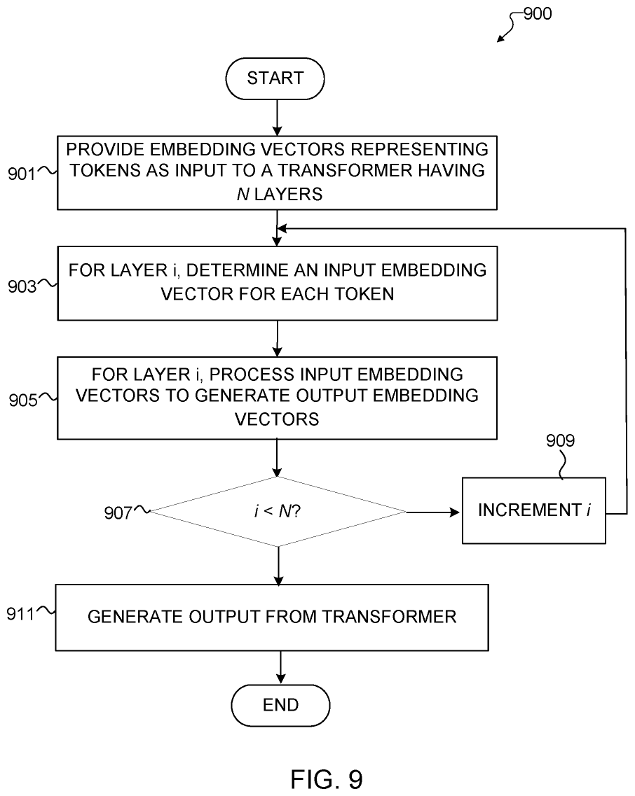

FIG. 9 illustrates an example method 900 for using residual transformers in natural language processing according to this disclosure. For ease of explanation, the method 900 shown in FIG. 9 is described as involving the electronic device 101 shown in FIG. 1 and one or more of the architectures disclosed in FIGS. 2 through 8. However, the method 900 shown in FIG. 9 could be used with any other suitable device(s) and architecture(s).

As shown in FIG. 9, at operation 901, embedding vectors representing tokens are provided in an input to a transformer that includes multiple transformer layers arranged in a sequence. Each transformer layer has a residual connection to each previous transformer layer. This could include, for example, the electronic device 101 providing embedding vectors 202, representing tokens of a natural language utterance, as an input to the transformer 200 or the transformer 400.

At operation 903, for a given transformer layer i, an input embedding vector is determined for each of the tokens. Each input embedding vector is based on a combination of output embedding vectors from previous transformer layers. This could include, for example, the electronic device 101 determining, for one of the transformer layers 201a-201n (such as the transformer layer 201c), an input embedding vector for each of the tokens. The input embedding vector is based on a combination of output embedding vectors 215 and 220 from previous transformer layers (such as the transformer layer 201a and the transformer layer 201b)

At operation 905, for the transformer layer i, processing, for the first token, the input embedding vector for each token is processed to generate an output embedding vector to be provided to each subsequent transformer layer. This could include, for example, the electronic device 101 processing the input embedding vector for each token to generate output embedding vectors 215 (which are provided to the adjacent subsequent transformer layer (such as the transformer layer 201d) and residual embedding vectors 220 (which are provided to non-adjacent subsequent transformer layers (such as layers above the transformer layer 201d).

At operation 907, it is determined if there are additional layers in the transformer to be processed. This could include, for example, the electronic device 101 determining if i is less than N (the number of transformer layers in transformer 200). If there are additional layers in the transformer, then the method 900 moves to operation 909, where the transformer layer index i is incremented by one, and the method 900 returns to operation 903 for processing of the next transformer layer. Otherwise, the method 900 moves to operation 911.

At operation 911, an output is generated from the transformer. This could include, for example, the electronic device 101 generating a solution to a natural language task from the transformer 200, where the solution is based on the natural language utterance input to the transformer 200.

Although FIG. 9 illustrates one example of a method 900 for using residual transformers in natural language processing, various changes may be made to FIG. 9. For example, while shown as a series of steps, various steps in FIG. 9 could overlap, occur in parallel, occur in a different order, or occur any number of times.

Note that the various embodiments of this disclosure can be applied in a variety of natural language processing use cases, including machine translation, text summarization, information retrieval, question answering systems, sentence and text representations, text classification, named entity recognition, parts-of-speech extraction, slot filling, and the like. The disclosed embodiments can improve performance in these and other use cases, and can also achieve faster training times, which results in more efficient use of resources.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
providing embedding vectors representing tokens in an input to a transformer comprising multiple transformer layers arranged in a sequence, each transformer layer having a residual connection to each previous transformer layer; and
for each transformer layer:
determining, for a first token, an input embedding vector based on a combination of output embedding vectors from previous transformer layers; and
processing, for the first token, the input embedding vector to generate an output embedding vector to be provided to each subsequent transformer layer.

2. The method of claim 1, wherein determining, for the first token, the input embedding vector comprises:
receiving a first set of output embedding vectors from the previous transformer layers, each output embedding vector in the first set output by one of the previous transformer layers for the first token;
determining a first set of attention weights for the first set of output embedding vectors; and
determining the input embedding vector by calculating a weighted sum of the first set of output embedding vectors based on the first set of attention weights.

3. The method of claim 2, wherein determining, for the first token, the input embedding vector further comprises:
for each other token in the input different from the first token:
receiving a second set of output embedding vectors from the previous transformer layers, each output embedding vector in the second set output by one of the previous transformer layers for the other token; and
determining a second set of attention weights for the second set of output embedding vectors; and
determining the input embedding vector by calculating a weighted sum of the first set of output embedding vectors and the second sets of output embedding vectors based on the first set of attention weights and the second sets of attention weights.

4. The method of claim 1, wherein:
the transformer includes multiple heads; and
determining, for the first token, the input embedding vector further comprises:
for a given transformer layer:
performing self-attention for each of the multiple heads to determine a weighted sum of output embedding vectors for all tokens from all the previous transformer layers for a same head; and
combining the weighted sums for the multiple heads.

5. The method of claim 4, wherein the self-attention attributed to at least one of the previous transformer layers is down-weighted using a bias parameter to reduce an impact of at least one previous transformer layer.

6. The method of claim 1, wherein:
the transformer includes multiple heads; and
determining, for the first token, the input embedding vector further comprises:
for a given transformer layer:
performing self-attention for each of the multiple heads to determine a weighted sum of output embedding vectors for all tokens from all the previous transformer layers for a same head and each other head of the multiple heads; and
combining the weighted sums for the multiple heads.

7. The method of claim 6, wherein the transformer includes a feed forward network for each of the multiple heads.

8. The method of claim 1, wherein each output embedding vector includes information indicating from which of the transformer layers the output embedding vector was output.

9. An electronic device comprising:
at least one imaging sensor configured to capture multiple image frames of a scene; and
at least one processing device configured to:
provide embedding vectors representing tokens in an input to a transformer comprising multiple transformer layers arranged in a sequence, each transformer layer having a residual connection to each previous transformer layer; and
for each transformer layer:
determine, for a first token, an input embedding vector based on a combination of output embedding vectors from previous transformer layers; and
process, for the first token, the input embedding vector to generate an output embedding vector to be provided to each subsequent transformer layer.

10. The electronic device of claim 9, wherein to determine, for the first token, the input embedding vector, the at least one processing device is configured to:
receive a first set of output embedding vectors from the previous transformer layers, each output embedding vector in the first set output by one of the previous transformer layers for the first token;
determine a first set of attention weights for the first set of output embedding vectors; and
determine the input embedding vector by calculating a weighted sum of the first set of output embedding vectors based on the first set of attention weights.

11. The electronic device of claim 10, wherein to determine, for the first token, the input embedding vector, the at least one processing device is further configured to:
for each other token in the input different from the first token:
receive a second set of output embedding vectors from the previous transformer layers, each output embedding vector in the second set output by one of the previous transformer layers for the other token; and
determine a second set of attention weights for the second set of output embedding vectors; and
determine the input embedding vector by calculating a weighted sum of the first set of output embedding vectors and the second sets of output embedding vectors based on the first set of attention weights and the second sets of attention weights.

12. The electronic device of claim 9, wherein:
the transformer includes multiple heads; and
to determine, for the first token, the input embedding vector, the at least one processing device is configured to:
for a given transformer layer:
perform self-attention for each of the multiple heads to determine a weighted sum of output embedding vectors for all tokens from all the previous transformer layers for a same head; and
combine the weighted sums for the multiple heads.

13. The electronic device of claim 12, wherein the self-attention attributed to at least one of the previous transformer layers is down-weighted using a bias parameter to reduce an impact of at least one previous transformer layer.

14. The electronic device of claim 9, wherein:
the transformer includes multiple heads; and
to determine, for the first token, the input embedding vector, the at least one processing device is configured to:
for a given transformer layer:
perform self-attention for each of the multiple heads to determine a weighted sum of output embedding vectors for all tokens from all the previous transformer layers for a same head and each other head of the multiple heads; and
combine the weighted sums for the multiple heads.

15. The electronic device of claim 14, wherein the transformer includes a feed forward network for each of the multiple heads.

16. The electronic device of claim 9, wherein each output embedding vector includes information indicating from which of the transformer layers the output embedding vector was output.

17. A non-transitory machine-readable medium containing instructions that when executed cause at least one processor of an electronic device to:
provide embedding vectors representing tokens in an input to a transformer comprising multiple transformer layers arranged in a sequence, each transformer layer having a residual connection to each previous transformer layer; and
for each transformer layer:
determine, for a first token, an input embedding vector based on a combination of output embedding vectors from previous transformer layers; and
process, for the first token, the input embedding vector to generate an output embedding vector to be provided to each subsequent transformer layer.

18. The non-transitory machine-readable medium of claim 17, wherein the instructions that cause the at least one processor to determine, for the first token, the input embedding vector comprise instructions to:
receive a first set of output embedding vectors from the previous transformer layers, each output embedding vector in the first set output by one of the previous transformer layers for the first token;
determine a first set of attention weights for the first set of output embedding vectors; and
determine the input embedding vector by calculating a weighted sum of the first set of output embedding vectors based on the first set of attention weights.

19. The non-transitory machine-readable medium of claim 18, wherein the instructions that cause the at least one processor to determine, for the first token, the input embedding vector further comprise instructions to:
for each other token in the input different from the first token:
receive a second set of output embedding vectors from the previous transformer layers, each output embedding vector in the second set output by one of the previous transformer layers for the other token; and
determine a second set of attention weights for the second set of output embedding vectors; and
determine the input embedding vector by calculating a weighted sum of the first set of output embedding vectors and the second sets of output embedding vectors based on the first set of attention weights and the second sets of attention weights.

20. The non-transitory machine-readable medium of claim 17, wherein:
the transformer includes multiple heads; and
wherein the instructions that cause the at least one processor to determine, for the first token, the input embedding vector comprise instructions to:
for a given transformer layer:
perform self-attention for each of the multiple heads to determine a weighted sum of output embedding vectors for all tokens from all the previous transformer layers for a same head; and
combine the weighted sums for the multiple heads.
